(19) United States
(12) Patent Application Publication
(10) Pub. No.: US 2026/0206077 A1
(43) Pub. Date: Jul. 16, 2026

(54) COMMUNICATION APPARATUS AND COMMUNICATION METHOD FOR EXTRA LTF IN SOUNDING

(71) Applicant: Panasonic Intellectual Property Corporation of America, Torrance, CA (US)

(72) Inventors: Yanyi DING, Singapore (SG); Yoshio URABE, Nara (JP); Hiroyuki MOTOZUKA, Kanagawa (JP)

(21) Appl. No.: 19/135,188

(22) PCT Filed: Oct. 30, 2023
(86) PCT No.: PCT/SG2023/050723

§ 371 Date: Jun. 3, 2025

(30) Foreign Application Priority Data
Dec. 16, 2022 (SG) 10202260473W

(51) Int. Cl. H04W 76/14; H04L 25/02; H04W 72/044; H04W 84/12

(52) U.S. Cl. CPC H04W 76/14; H04L 25/0224; H04W 72/046; H04W 84/12

(57) ABSTRACT

Apparatuses and methods for providing multiple structures and methods to enable enhanced reliability and improved channel estimation in wireless local area network (WLAN) communications in wireless local area network (WLAN) communications by providing apparatuses and methods for extra long training field (LTF) symbol use in channel estimation in sounding are provided. An exemplary communication apparatus operating as an access point in a wireless local area network (WLAN) including a transmitter and circuitry. In operation, the transmitter is configured to transmit signals to at least one peer communication apparatus in the WLAN. In operation, the circuitry generates a first signal to initiate a sounding procedure, wherein the first signal comprises first information to indicate to the at least one peer communication apparatus spatial stream allocation information, and wherein the transceiver transmits the first signal to the at least one peer communication apparatus.

### TECHNICAL FIELD

The present invention relates generally to wireless local area network (WLAN) communication, and more particularly relates to communication apparatuses and communication methods for an extra LTF (long training field) in sounding within WLAN communication systems.

### BACKGROUND

Communication apparatuses are prevalent in today's world in the form of phones, tablets, computers, cameras, digital audio/video players, wearable devices, game consoles, telehealth/telemedicine devices, and vehicles providing communication functionality, and various combinations thereof. The communication may include exchanging data through, for example, a WLAN system, a cellular system, a satellite system, and various combinations thereof.

WLAN systems utilize multiple user (MU) communication protocols such as orthogonal frequency-division multiple access (OFDMA) and multiple-input multiple-output (MIMO) protocols. In support of extremely high throughput (EHT) for next generation WLAN communication, the 802.11be standard is being developed. In 802.11be, in order to improve the MIMO channel estimation for the reception of non-OFDMA EHT MU physical layer protocol data unit (PPDU) or EHT sounding Null Data PPDU (NDP), the number of EHT long training field symbols (EHT-LTFs) may be larger than the initial number of EHT-LTFs determined by the total number of spatial streams (SSs).

In the WLAN preamble, the legacy long training field (LTF) is used for fine carrier frequency offset synchronization and fine time synchronization while the non-legacy long training field (LTF) is used for channel estimation. In the standardization of next-generation WLAN, a new radio access technology (Ultra High Reliability) necessarily having backward compatibility with IEEE 802.11a/b/g/n/ac/ax/be technologies has been discussed in a UHR Study Group. In particular, methods to improve performance of EHT MU PPDU transmission by assigning extra EHT-LTFs to certain spatial streams/receiver STAs has been discussed. According to the discussion, Multi-AP operation will be a strong potential feature for UHR WLAN.

Yet, in Multi-AP scenarios, the requirement for channel estimation accuracy in sounding can be different between different groups of STAs. And higher channel estimation accuracy leads to a higher-quality subsequent beamformed transmission. In addition, data with a higher modulation coding scheme (MCS) requires higher transmission quality. Further, groups of STAs for low latency traffic require higher reliability and groups of STAs in a higher interference environment require more accurate beamforming.

Thus, there is a need for communication apparatuses and communication methods to alleviate the aforementioned issues within WLAN communication systems, particularly in multi-AP WLAN environments. Furthermore, other desirable features and characteristics will become apparent from the subsequent detailed description and the appended claims, taken in conjunction with the accompanying drawings and this background.

### SUMMARY

One non-limiting and exemplary embodiment facilitates providing multiple communication apparatuses and methods to enable enhanced reliability and improved channel estimation in wireless local area network (WLAN) communications by providing apparatuses and methods for extra long training field (LTF) symbol use in channel estimation in sounding.

In an embodiment, the techniques disclosed herein feature a communication apparatus operating as an access point in a wireless local area network (WLAN) including a transmitter and circuitry. In operation, the transmitter is configured to transmit signals to at least one peer communication apparatus in the WLAN. In operation, the circuitry generates a first signal to initiate a sounding procedure, wherein the first signal comprises first information to indicate to the at least one peer communication apparatus spatial stream allocation information, and wherein the transceiver transmits the first signal to the at least one peer communication apparatus.

In another embodiment, the techniques disclosed herein feature a communication apparatus including a receiver, circuitry and a transmitter. In operation, the circuitry receives a first signal to initiate a sounding procedure, wherein the first signal comprises first information to indicate to the at least one wireless station spatial stream allocation information, and wherein the circuitry decodes the first signal, obtains the first information, and generates a second signal solicited by the first signal. The transmitter is coupled to the circuitry and configured to transmit the second signal to the at least one access point.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1A depicts an exemplary wireless local area network (WLAN) system and communication apparatuses operating therein, wherein FIG. 1A depicts the exemplary WLAN system,

FIG. 1B depicts a block diagram of an exemplary wireless station (STA) communication apparatus operating in the WLAN system of FIG. 1A;

FIG. 1C depicts a block diagram of an exemplary wireless access point (AP) operating in the WLAN system of FIG. 1A;

FIG. 2 is an illustration of a single-access point based multi-user trigger-based sounding procedure in an Extremely High Throughput (EHT) WLAN system;

FIG. 3 is an illustration of exemplary Ultra High Reliability (UHR) long training field (LTF) symbols in accordance with the present disclosure;

FIG. 4 is an illustration of a single access point (AP) explicit sounding procedure in an Ultra High Reliability (UHR) WLAN system in accordance with the present disclosure;

FIG. 5 is an illustration of a UHR NDP Announcement frame in accordance with the present disclosure;

FIG. 6 is an illustration of a variation of the UHR NDP Announcement frame in accordance with the present disclosure;

FIG. 7 is an illustration of a UHR sounding NDP frame in accordance with the present disclosure;

FIG. 8 is an illustration of an extra UHR-LTF information field in accordance with the present disclosure;

FIG. 9A depicts, in accordance with the present disclosure, a matrix used for a first option for generation of UHR-LTF symbols in accordance with the present disclosure;

FIG. 9B depicts, in accordance with the present disclosure, the first option of generating UHR-LTF symbols using the matrix of FIG. 9A;

FIG. 10A depicts, in accordance with the present disclosure, a first matrix used in a second option for generation of UHR-LTF symbols using different matrices;

FIG. 10B depicts, in accordance with the present disclosure, a second matrix different from the first matrix of FIG. 10A used in the second option of generating the Extra UHR-LTF symbols using different matrices;

FIG. 11 is an illustration of a multi access point (AP) based explicit sounding in accordance with the present disclosure;

FIG. 12 is an illustration of an exemplary initiator frame format for multi-AP based explicit sounding in accordance with the present disclosure;

FIG. 13 is a flowchart of a UHR-LTF generation procedure in a UHR sounding NDP for explicit sounding in accordance with the present disclosure;

FIG. 14 is a flowchart of a decoding procedure for the UHR-LTF field in the UHR Sounding NDP by a non-AP STA in accordance with the present disclosure;

FIG. 15 is an illustration of a single-AP based implicit sounding procedure in accordance with the present disclosure;

FIG. 16 is an illustration of a UHR NDP Announcement frame format in accordance with the present disclosure;

FIG. 17 is an illustration of a Per STA Info subfield in accordance with the present disclosure;

FIG. 18 is an illustration of a multi-AP based implicit sounding procedure in accordance with the present disclosure;

FIG. 19 is an illustration of an exemplary initiator frame format in accordance with the present disclosure;

FIG. 20 is an illustration of an exemplary UHR-LTF Allocation of a Per. AP Info subfield in accordance with the present disclosure;

FIG. 21 is an illustration of a UHR NDP Announcement frame format in accordance with the present disclosure;

FIG. 22A depicts, in accordance with the present disclosure, a first option of a Per STA Info subfield;

FIG. 22B depicts, in accordance with the present disclosure, a second option of a Per STA Info subfield;

FIG. 23 is an illustration of UHR NDP sounding frames sent by two STAs to AP(s) in accordance with the present disclosure; and

FIG. 24 is a flowchart of a UHR-LTF filed generation procedure in UHR Sounding NDP by a non-AP STA in accordance with the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description. It is the intent of the present disclosure to present exemplary embodiments of communication apparatuses and communication methods for providing extra long training field symbols (extra-LTFs) to certain spatial streams (SSs)/receiver stations (STAs) during sounding to increase channel estimation accuracy and especially during Multi-AP sounding procedures where the requirements for channel estimation accuracy may be different between different groups of STAs.

It is understood that higher channel estimation accuracy leads to a higher-quality subsequent beamformed transmission. As data with higher modulation coding scheme (MCS) requires higher transmission quality, groups of STAs for low latency traffic require higher reliability, and groups of STAs in a higher-interference environment requires more accurate beamforming, assigning extra-LTFs to certain SSs/receiver STAs in sounding and especially Multi-AP sounding procedures advantageously addresses these and other quality and reliability issues.

Thus, in an ultra-high reliability (UHR) multiple-user (MU) sounding procedure in accordance with the present embodiments, the AP/coordinator AP may divide UHR-LTF symbols of the UHR Sounding null data PPDU (NDP) into two groups for calculating the channel estimation: (1) initial UHR-LTF symbols and (2) extra UHR-LTF symbols. The initial UHR-LTF symbols are for all spatial streams and the number of initial UHR-LTF symbols may be larger than the total number of spatial streams. The extra UHR-LTF symbols are for specific one or more spatial streams and the Extra UHR-LTF symbols carry channel information only for those specific spatial streams. Spatial expansion can be applied together with the extra UHR-LTF symbols to enhance the performance.

Prior to the UHR MU sounding procedure, relevant STA(s)/coordinated AP(s) may inform the AP/coordinator AP of the intendency to use Extra LTF symbols sounding the channel. The AP/coordinator AP shall also decide which spatial stream(s) the Extra UHR-LTF symbols will be assigned to based, for example, on channel conditions and link adaptation feedback. Further, in the UHR MU sounding procedure, the AP/coordinator AP also indicates spatial streams and LTF information to STAs/coordinated AP(s), such as the number of spatial streams, the number of UHR-LTFs, the number of Extra UHR-LTF symbols, and an index of spatial streams being enhanced.

In accordance with an embodiment of the present disclosure, there are two options for usage of extra UHR-LTF symbols. In accordance with the first option, the extra UHR-LTF symbols, together with the Initial UHR-LTF symbols, are assigned to all spatial streams evenly. And in accordance with the second option, the extra UHR-LTF symbols, upon the initial UHR-LTF symbols, are assigned to spatial streams unevenly.

The transmission of a UHR Sounding NDP may be carried out in a UHR MU sounding procedure in either explicit sounding or implicit sounding as described hereinafter, where each of the explicit and implicit sounding may be based on a single access point (AP) or based on multiple APs. The single-AP based sounding procedure can be a sequential part of a multi-AP based sounding procedure. As to the multi-AP procedures, these can involve any multi-AP transmission types such as coordinated transmission (e.g., coordinated OFDMA (C-OFDMA), coordinated spatial reuse (C-SR), or coordinated beamforming (C-BF)) or joint transmission (JXT).

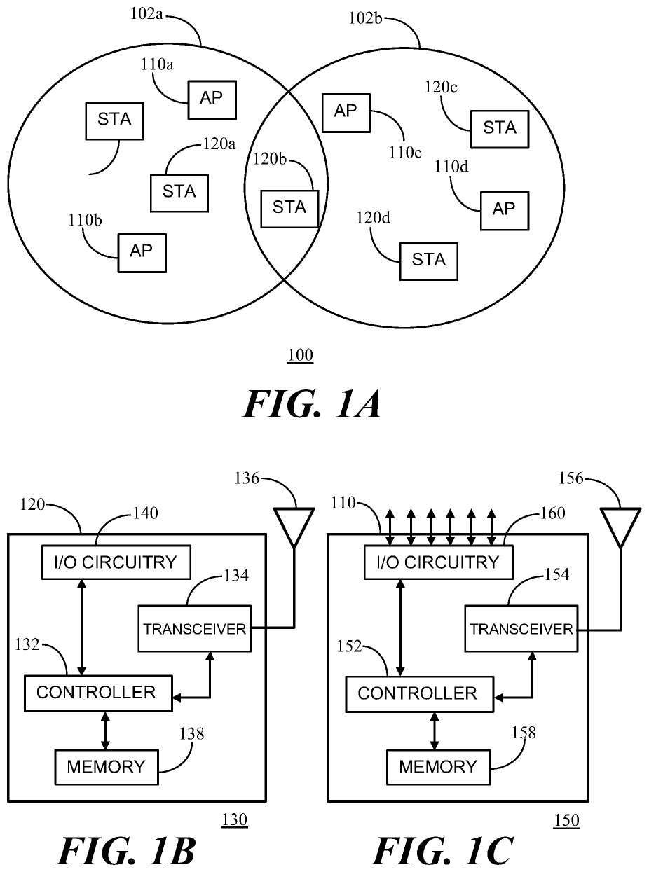

Referring to FIG. 1A, an illustration 100 depicts an exemplary WLAN system. In a dense WLAN environment, some of the areas of service (Basic Service Sets (BSS)) 102a, 102b respectively include multiple access points (APs) 110a/110b and 110c/110d and are defined to have overlapping areas of service 102a, 102b for improved service coverage as shown in the illustration 100. Within the areas of service 102a, 102b, wireless stations (STAs) 120a, 120b, 120c, 120d communicate with one or more of the APs 110a, 110b, 110c, 110d. When there are multiple APs within a BSS (e.g., APs 110a and 110b in BSS 102a), one of the multiple APs acts as a “coordinating AP” for itself and the other APs within the BSS and the other APs within the BSS are referred to as “coordinated APs”.

The wireless stations (STAs) are communication apparatuses operating in a WLAN system. FIG. 1B is a block diagram 130 of an exemplary STA 120. The STA 120 may comprise a device such as a controller 132 which is coupled to a communication device, such as a transceiver 134, connected to an antenna 136 for performing a function of communication as described in the present disclosure. The transceiver 134 includes at least a transmitter and a receiver. For example, the STA 120 may comprise the controller 132 that generates control signals and/or data signals which are used by the transceiver 134 to perform a communication function of the STA 120. The STA 120 may also comprise a memory 138 coupled to the controller 132 for storage of instructions and/or data for generation of the control signals and/or data signals by the controller 132. The STA 120 may also include input/output (I/O) circuitry 140 coupled to the controller 132 for receiving input of data and/or instructions for storage in the memory 138 and/or for generation of the control signals and/or data signals and for providing output of data in the form of audio, video, textual or other media.

The STAs 120 communicate with the access points (APs) 110 in the WLAN system 100 to access resource units (RU) for exchanging data with the internet, other communication apparatuses or other systems. FIG. 1C is a block diagram 150 of an exemplary AP 110. The AP 110 may comprise an infrastructure facility which communicates with or controls STAs, such as STAs 120a, 120b, 120c, 120d illustrated in FIG. 1A or STA 120 illustrated in FIG. 1B or other communication apparatuses. The AP 110 may comprise a device such as a controller 152 which is coupled to a communication device, such as a transceiver 154, connected to an antenna 156, for performing a function of communication as described in the present disclosure. The transceiver 154 includes at least a transmitter and a receiver. For example, the AP 110 may comprise the controller 152 that generates control signals and/or data signals which are used by the transceiver 154 to perform a communication function of the AP 110 with a STA. for example the STA 120 in FIG. 1B. The AP 110 may also comprise a memory 158 coupled to the controller 152 for storage of instructions and/or data for generation of the control signals and/or data signals by the controller 152. The AP 110 may also include input/output (I/O) circuitry 160 coupled to the controller 152 for coupling with various RUs and for receiving input of data and/or instructions for storage in the memory 158 and/or for generation of the control signals and/or data signals to enable communication between the STAs (e.g., STA 120 in FIG. 1B) to the RUs. It can be seen that the structure of the APs 110 and the STAs 120 communication apparatuses are similar and one of the APs 110 or STAs 120 can refer to other APs and STAs within a WLAN as peer communication apparatuses.

To increase transmission reliability of WLAN connectivity, the standardization of next-generation WLAN proposes a new radio access technology called Ultra High Reliability (UHR) having backward compatibility with IEEE 802.11a/b/g/n/ac/ax/be technologies. In particular, methods to improve performance of EHT MU PPDU transmission by assigning extra EHT-LTFs to certain spatial streams/receiver STAs has been proposed.

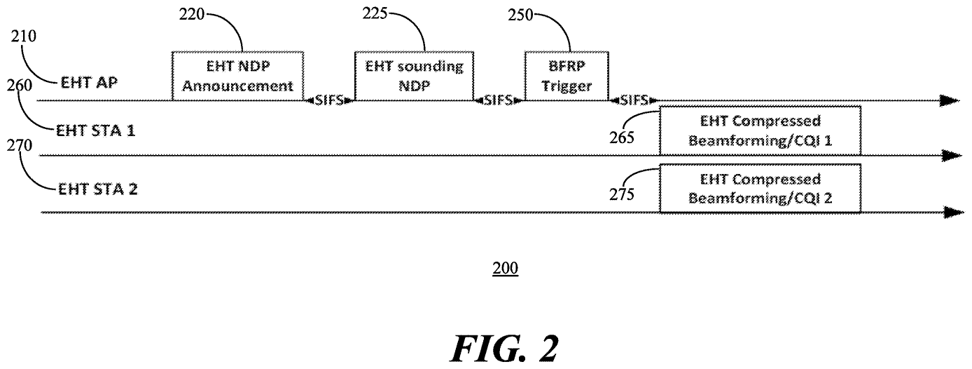

FIG. 2 depicts an exemplary illustration 200 of a single-access point (AP 210) based multi-user trigger-based sounding procedure in an EHT WLAN system. The access point (AP) 210 transmits an EHT NDP announcement 220 followed by an EHT sounding NDP 225. Thereafter, the AP 210 sends a beamforming report poll (BFRP) trigger 250. As shown in FIG. 2, the EHT NDP announcement 220, EHT sounding NDP 225, and the BFRP trigger 250 may be separated by a corresponding Short Interframe Space (SIFS). In response to the BFRP trigger 250, a first EHT STA 260 (EHT STA 1) transmits a EHT compressed beamforming channel quality indicator (CQI) 265 to the AP 210 and a second EHT STA 270 (EHT STA 2) transmits a EHT compressed beamforming/channel quality indicator 2 (CQI 2) 275 to the AP 210. Also, there may be SIFS between the BFRP trigger 250 and the EHT compressed beamforming/CQI 265 or 275, as shown in FIG. 2.

The EHT compressed beamforming/CQI is based on channel estimation of beamforming/CQI based on the reception of the BFRP trigger 250. However, in a UHR WLAN scenario, the issue is more complicated as the requirement for channel estimation accuracy in sounding may be different between STAs and high channel estimation accuracy is necessary for efficient ultra-high reliability WLAN protocol.

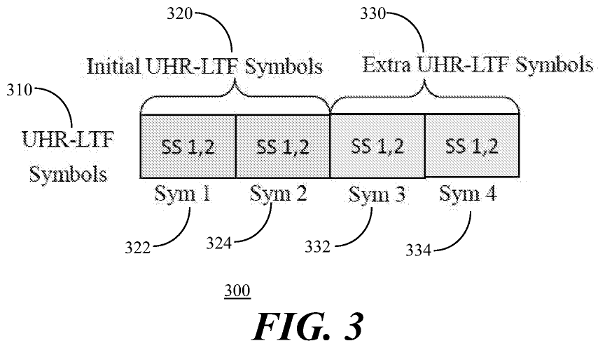

In the WLAN preamble, the legacy long training field (LTF) is used for fine carrier frequency offset synchronization and fine time synchronization, while non-legacy long training field (LTF) is used for channel estimation. FIG. 3 depicts an illustration 300 of Ultra High Reliability (UHR) long training field (LTF) symbols 310. The UHR-LTF symbols 310 may include initial UHR-LTF symbols 320 and Extra UHR-LTF symbols 330. In accordance with an embodiment of the present disclosure, the Extra UHR-LTF symbols 330, together with the Initial UHR-LTF symbols 320, are assigned to all spatial streams evenly. Thus, when the number of spatial streams is “two”, the number of UHR-LTF symbols is “four” wherein the initial UHR-LTF symbols 320 include a first symbol 322 (Sym 1) and a second symbol 324 (Sym 2) and the Extra UHR-LTF symbols 330 include its first symbol 332 (e.g., Sym 3, as shown in FIG. 3) and second symbol 334 (e.g., Sym 4, as shown in FIG. 3). The structure of the UHR-LTF symbols 310 in accordance with the present disclosure is applicable to all sounding types and no signaling change is needed.

The frequency domain signal before cyclic shift diversity (CSD) transmitted in the k^{th} subcarrier of the m^{th} (m≥1) spatial stream is generated in accordance with Equation (1).

$${UHRLTF}^{f} = {[ {P}_{UHRLTF} ]}_{m , n} {UHRLTF}_{k} ( n \leq {N}_{total\_UHRLTF} ) \qquad ( 1 )$$

where P_{UHRLTF} is the P matrices which are defined in IEEE 802.11-2016 standard (the dimension being decided by the total number of UHR-LTF symbols), UHRLTFₖ is the UHR-LTF sequences applied on subcarrier k, and N_{total_UHRLTF} is the total number of UHR-LTF symbols.

The number of spatial streams (Nss), the corresponding initial number of UHR-LTF symbol (initial N_UHR-LTF), the total number of UHR-LTF symbol (N_UHR-LTF), and the mathematical number of UHR-LTFs carrying a single spatial stream (SS) when there is Extra UHR-LTF (N_UHR-LTFs/SS) are shown in Table 1.

TABLE 1

| Nss | Initial N_UHR-LTF | N_UHR-LTF | N_UHR-LTFs/SS |
|---|---|---|---|
| 1 | 1 | 2 | 2 |
| 2 | 2 | 4 | 2 |
| 3 | 4 | 8 | 2.7 |
| 4 | 4 | 8 | 2 |
| 5 | 6 | 8 | 1.6 |
| 6 | 6 | 8 | 1.3 |
| 7 | 8 | 8 | 1.1 |
| 8 | 8 | 8 | 1 |

Note:
the more UHR-LTFs are used to carry a single SS, the better the gain is.

With an even benefit for all spatial streams, when the number of spatial streams (Nss) is greater than 4, the gain as indicated by N_UHR-LTFs/SS is not obvious (i.e., the gain is 1.1~1.6).

The Extra UHR-LTF symbols 330, upon the Initial UHR-LTF symbols 320, are assigned to spatial streams unevenly in an explicit sounding procedure.

A Single-AP based explicit sounding procedure is initiated by an UHR NDP Announcement frame sent by the AP.

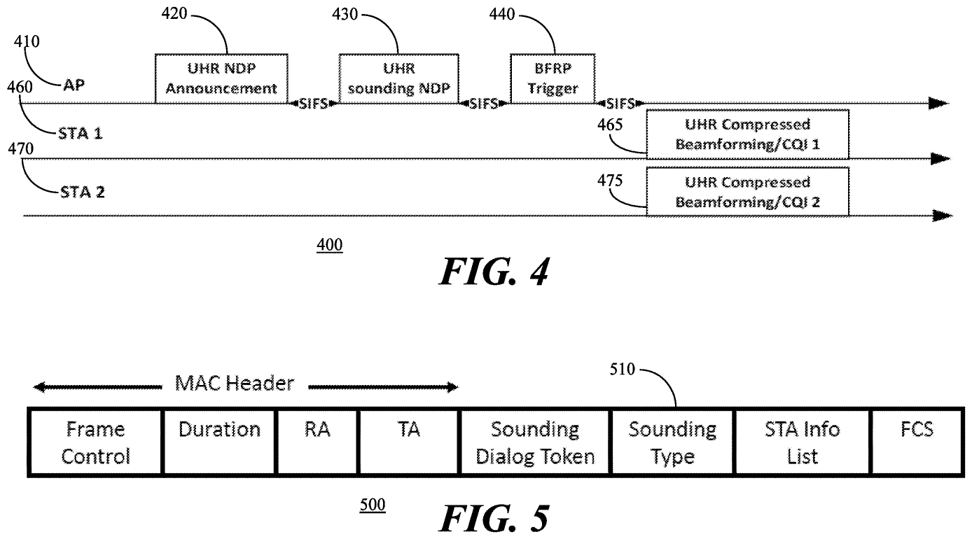

Referring to FIG. 4, an illustration 400 depicts a single-access point 410 based explicit sounding procedure in an UHR WLAN system in accordance with the present disclosure. The single-AP based explicit sounding procedure is initiated by a UHR NDP Announcement frame 420 transmitted by the AP 410. The UHR NDP Announcement frame 420 is followed by a UHR sounding NDP 430. Thereafter, the AP 410 sends a beamforming report poll (BFRP) trigger 440. In response to the BFRP trigger 440, a first STA 460 transmits a UHR compressed beamforming channel quality indicator (CQI) 465 to the AP 410 (STA 1 in FIG. 4) and a second STA 470 (STA 2 in FIG. 4) transmits a UHR compressed beamforming/channel quality indicator 2 (CQI 2) 475 to the AP 410. In the UHR NDP Announcement frame 420 or the UHR sounding NDP 430, the Extra-LTF information for each STA/SS is indicated. The receiver STAs 460, 470 shall generate and send the beamforming feedback 465, 475 based on enhanced channel estimation calculated from the UHR sounding NDP if there is an Extra UHR-LTF 330 assigned. In accordance with an embodiment of the present disclosure, the size of the UHR Compressed Beamforming feedback 465, 475 is advantageously smaller because only a channel state information of specific spatial streams is fed back. It will be appreciated that the UHR NDP Announcement frame 420, the UHR sounding NDP 430, and the BFRP trigger 440 are separated by a respective SIFS. There is also a SIFS between the BFRP trigger 440 and the beamforming feedback 465 and between the BFRP trigger 440 and the beamforming feedback 475.

FIG. 5 depicts an illustration 500 of a UHR NDP announcement frame 420 format. In a Sounding Type field 510, the type of sounding that will be initiated is specified in accordance with the present disclosure. For example, sounding types indicated by the field 510 may include: multi-AP based implicit sounding, multi-AP based explicit sounding, single-AP based implicit sounding, single-AP based explicit sounding (as shown in FIG. 4), multi-AP based hybrid sounding, and single-AP based hybrid sounding.

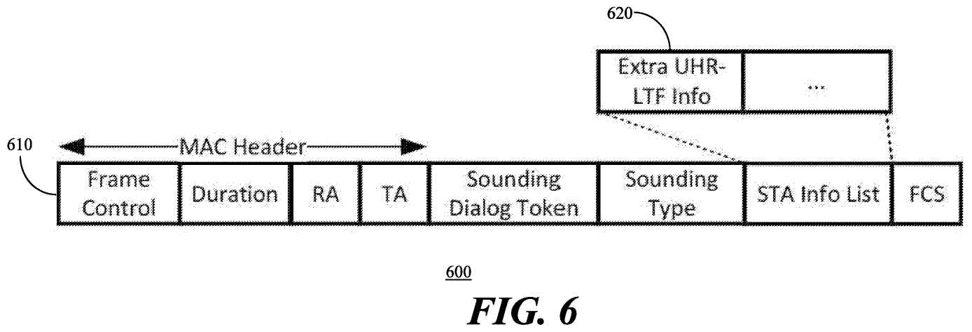

As indicated in an illustration 600 of a variation of the UHR NDP Announcement frame 610 in accordance with the present disclosure in FIG. 6, the usage of Extra UHR-LTF symbols 330 in the subsequent UHR Sounding NDP 430 may be indicated 620 in the UHR NDP Announcement frame 610.

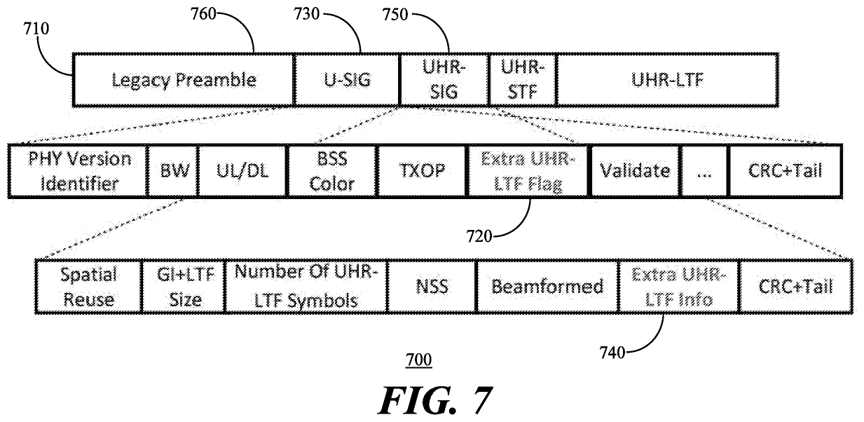

FIG. 7 depicts an illustration 700 of an exemplary format of a UHR Sounding NDP 710. The usage of Extra UHR-LTF symbols in UHR Sounding NDP may be indicated in the preamble such as an extra UHR-LTF flag field 720 in the U-SIG field 730 and an extra UHR-LTF information field 740 in the UHR-SIG field 750. As mentioned above, a legacy preamble, such as legacy preamble 760, includes LTF symbols for functions such as fine carrier frequency offset synchronization and fine time synchronization, while non-legacy long training field (LTF) is used for channel estimation. The UHR LTF symbols or EHT LTF symbols are non-legacy LTF symbols used for channel estimation.

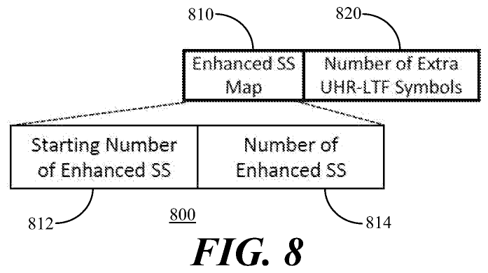

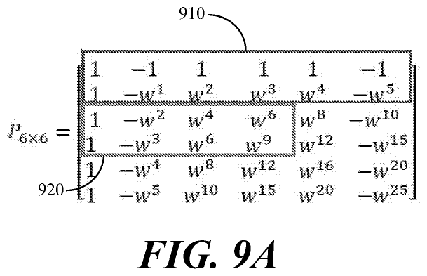

Referring to FIG. 8, an exemplary structure of the extra UHR-LTF information field 800 is depicted. The extra UHR-LTF information field 800 may include an Enhanced SS Map subfield 810 and a Number of Extra UHR-LTF Symbols subfield 820. The Enhanced SS Map subfield 810 may indicate a starting number of spatial streams 812 and a total number of spatial streams 814 that are enhanced. While this structure accommodates Extra UHR-LTF symbols assigned to different spatial streams, in order to reduce signaling bits, it can be predetermined that all Extra UHR-LTF symbols are assigned to a same spatial stream.

There are two options to generate UHR-LTF symbols when there is Extra UHR-LTF symbol(s) assigned to specific spatial stream(s). An example is used to understand UHR-LTF generation in accordance with the two options. The example involves a UHR sounding NDP that utilizes four spatial streams where the number of Initial UHR-LTF symbols 320 is four and the number of Extra UHR-LTF symbols 330 is two and where the Extra UHR-LTF symbols 330 are assigned to a first spatial stream (SS1) and a second spatial stream (SS2).

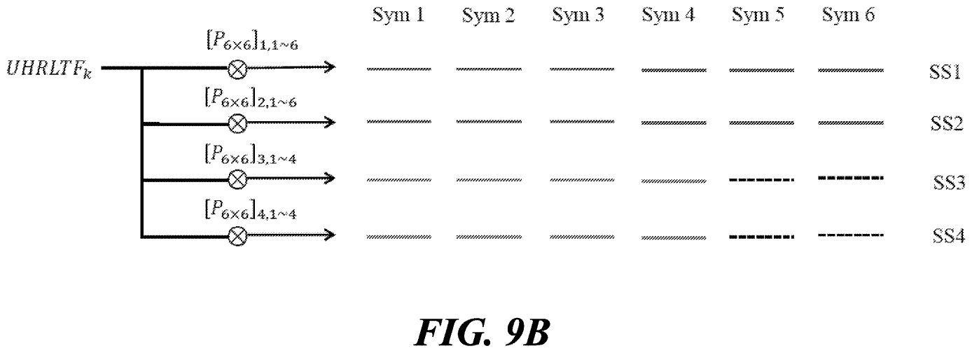

FIG. 9A depicts the first option used to generate six UHR-LTF symbols (four Initial UHR-LTF symbols and two Extra UHR-LTF symbols) using a same P_{6×6} matrix. FIG. 9B depicts the P^{6×6} matrix where a first sub-matrix 910 (e.g., a P_{2×6} sub-matrix) is used to generate SS1-2 of Symbols 1-6 (i.e., the first two rows of lines in FIG. 9A) and a second sub-matrix 920 (e.g., a P_{2×4} sub-matrix) is used to generate a third spatial stream to a fourth spatial stream SS3-4 of Symbols 1 to 4 (Sym 1-4) (i.e., the second two rows of lines in FIG. 9A) followed by Symbols 5 to 6 that are dummy-padded symbols as depicted with the dotted lines in FIG. 9B.

When generating the Initial UHR-LTF symbols together with the Extra UHR-LTF symbols in accordance with the first option, the frequency domain signal before cyclic shift diversity (CSD) transmitted in the k^{th} subcarrier of the m^{th} (m≥1) spatial stream is generated in accordance with Equation (2).

$${UHRLTF}^{f} = {[ {P}_{UHRLTF} ]}_{m , n} {UHRLTF}_{k} ( n \leq {N}_{A\_UHRLTF} ) \qquad ( 2 )$$

where P_{UHRLTF} is the P matrices which are defined in IEEE 802.11-2016 standard (the dimension being decided by the total number of UHR-LTF symbols), UHRLTFₖ is the UHR-LTF sequences applied on subcarrier k, and N_{A_UHRLTF} is the total number of UHR-LTF symbols assigned to the m^{th} spatial stream.

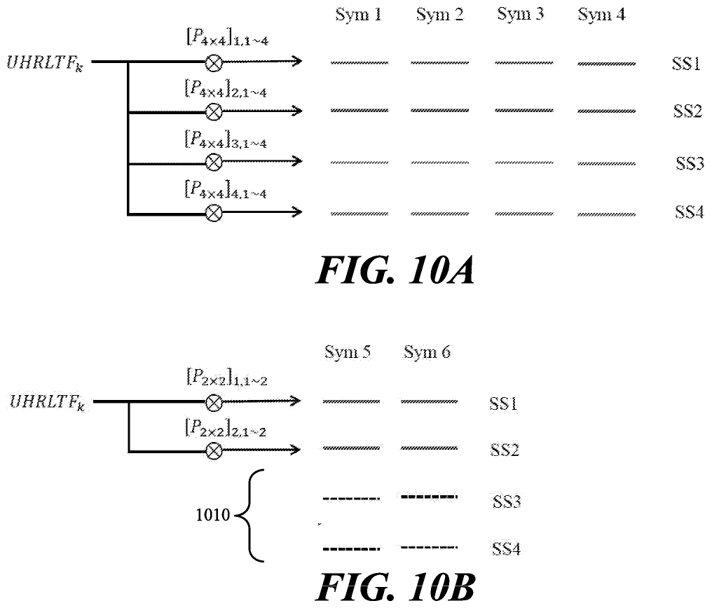

The second option in accordance with the present disclosure is to generate the Initial UHR-LTF symbols 320 and the Extra UHR-LTF symbols 330 separately using different P matrices. FIG. 10A depicts the second option of generating the Initial UHR-LTF symbols using a first matrix and FIG. 10B depicts the second option of generating the Extra UHR-LTF symbols using a second matrix. The first matrix may be a P_{4×4} matrix and the second matrix may be a P_{2×2} matrix, both of which are shown below.

$$\begin{matrix}FIRST MATRIX & \\ {P}_{4 \times 4} = [ \begin{matrix}1 & - 1 & 1 & 1 \\ 1 & 1 & - 1 & 1 \\ 1 & 1 & 1 & - 1 \\ - 1 & 1 & 1 & 1\end{matrix} ] & \end{matrix}$$

$$\begin{matrix}SECOND MATRIX & \\ {P}_{2 \times 2} = [ \begin{matrix}1 & - 1 \\ 1 & 1\end{matrix} ] & \end{matrix}$$

As seen in FIG. 10B, dummy bits 1010 are transmitted in spatial streams 3 and 4 in symbols 5 and 6.

When generating the Initial UHR-LTF symbols and the Extra UHR-LTF symbols separately in accordance with the second option, the frequency domain signal before cyclic shift diversity (CSD) transmitted in the k^{th} subcarrier of the m^{th} (m≥1) spatial stream across the initial UHR-LTF symbol(s) is generated in accordance with Equation (3).

$${UHRLTF}_{Initial}^{f} = {[ {P}_{UHRLTF} ]}_{m , n} {UHRLTF}_{k} ( n \leq {N}_{I\_UHRLTF} ) \qquad ( 3 )$$

where P_{UHRLTF} is the P matrices which are defined in IEEE 802.11-2016 standard (the dimension being decided by the total number of Initial UHR-LTF symbols), and N_{I_UHRLTF} is the total number of Initial UHR-LTF symbols assigned to the spatial streams.

The frequency domain signal before cyclic shift diversity (CSD) transmitted in the k^{th} subcarrier of the m^{th} (m≥1) spatial stream across the extra UHR-LTF symbol(s) is generated in accordance with Equation (4).

$${UHRLTF}_{Extra}^{f} = {[ {P}_{UHRLTF} ]}_{( m - STARTING\_STS \_NUM ) , n} {UHRLTF}_{k} \qquad ( 4 )$$

$$( n \leq {N}_{E\_UHRLTF} )$$

where P_{UHRLTF} is one of the P matrices which are defined in IEEE 802.11-2016 standard (the dimension being decided by the total number of Extra UHR-LTF symbols), and N_{E_UHRLTF} is the total number of Extra UHR-LTF symbols assigned to the spatial streams

If in a UHR Sounding NDP, the number of spatial streams (Nss) is four, the number of initial UHR-LTF symbols (N_Initial_UHR-LTF) is four, the number of extra UHR-LTF symbols (N_Extra_UHR-LTF) is two, and the Extra UHR-LTF symbols are assigned to SS1 and SS2, the generation of frequency domain signals in accordance with the two options of the present disclosure are shown below.

In regards to the first option, the frequency domain signal before CSD transmitted in the k^{th} subcarrier of the 1^{st} and 2^{nd} spatial stream across six frequency domain symbols is generated in accordance with Equation 5 and the frequency domain signal before CSD transmitted in the k^{th} subcarrier of the 3^{rd} and 4^{th} spatial stream across four frequency domain symbols is generated in accordance with Equation 6.

$${UHRLTF}^{f} = {[ {P}_{6 \times 6} ]}_{m , n} {UHRLTF}_{k} ( 1 \leq m \leq 2 , n \leq 6 ) \qquad ( 5 )$$

$${UHRLTF}^{f} = {[ {P}_{6 \times 6} ]}_{m , n} {UHRLTF}_{k} ( 3 \leq m \leq 4 , n \leq 4 ) \qquad ( 6 )$$

In regards to the second option, the frequency domain signal before CSD transmitted in the k^{th} subcarrier of the 1^{st} to 4^{th} spatial stream across four Initial UHR-LTF symbols is generated in accordance with Equation (7) and the frequency domain signal before CSD transmitted in the k^{th} subcarrier of the 1^{st} and 2^{nd} spatial stream across 2 Extra UHR-LTF symbols is generated in accordance with Equation (8).

$${UHRLTF}^{f} = {[ {P}_{4 \times 4} ]}_{m , n} {UHRLTF}_{k} ( 1 \leq m \leq 4 n \leq 4 ) \qquad ( 7 )$$

$${UHRLTF}^{f} = {[ {P}_{2 \times 2} ]}_{( m - STARTING\_STS \_NUM ) , n} {UHRLTF}_{k} ; \qquad ( 8 )$$

$$( 1 \leq m \leq 2 , n \leq 2 , STARTING\_STS \_NUM = 2 )$$

When a large number of spatial streams (N_{SS}) are used (e.g., 8<Nss≤16), the second option is preferred because no new designed P matrix for a large number of spatial streams is needed.

As mentioned hereinabove, improved, more accurate channel estimation in sounding or transmission is a quality of the methods and protocols in accordance with present disclosure. If Initial and Extra UHR-LTF symbols are generated together in accordance with the first option, the estimated channel matrix corresponding to subcarrier k is calculated by Equation (9).

$${\hat{H}}^{k} = \frac{{Y}_{k} \cdot {[ {P}_{UHRLTF} ]}^{H}}{{UHRLTF}_{k} \cdot {N}_{A\_UHRLTF}} \qquad ( 9 )$$

where Yₖ=[\vec{Y}_{k,1}, . . . , \vec{Y}_{k,N}_{_{A_UHRLTF}}] is a matrix of dimension N_{RX}×N_{A_UHRLTF} that collects the received signal vectors \vec{Y}_{k,n} corresponding to the k^{th} subcarrier and n^{th} UHR-LTF symbol.

If, on the other hand, the Initial and Extra UHR-LTF symbols are generated separately in accordance with the second option, the estimated channel matrix corresponding to subcarrier k is calculated by Equation (10).

$${\hat{H}}^{k} = \frac{1}{2} ( \frac{{Y}_{k 1} \cdot {[ {P}_{UHRLTF} ]}^{H}}{{UHRLTF}_{k} \cdot {N}_{I\_UHRLTF}} + \frac{{Y}_{k 2} \cdot {[ {P}_{UHRLTF} ]}^{H}}{{UHRLTF}_{k} \cdot {N}_{E\_UHRLTF}} ) \qquad ( 10 )$$

where Yₖ₁=[\vec{Y}_{k,1}, . . . , \vec{Y}_{k,N}_{_{I_UHRLTF}}] is a matrix of dimension N_{RX}×N_{I_UHRLTF} that collects the received signal vectors \vec{Y}_{k,n} corresponding to the k^{th} subcarrier and n^{th} Initial UHR-LTF symbol and Yₖ₂=[\vec{Y}_{k,1}, . . . , \vec{Y}_{k,N}_{_{E_UHRLTF}}] is a matrix of dimension N_{RX}×N_{E_UHRLTF} that collects the received signal vectors \vec{Y}_{k,n} corresponding to the k^{th} subcarrier and n^{th} Extra UHR-LTF symbol.

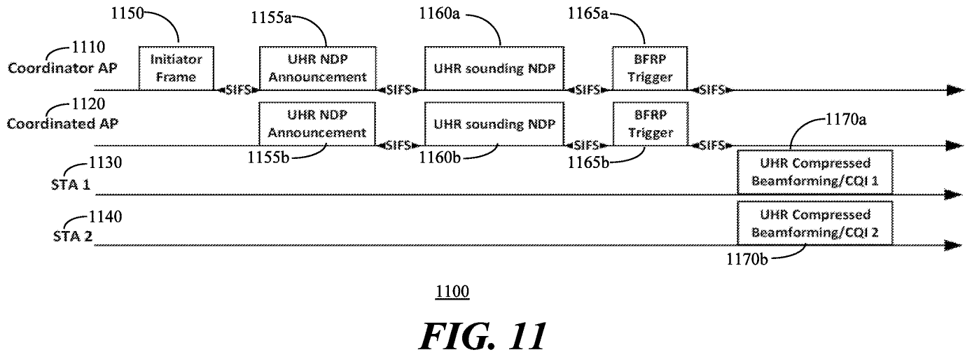

Turning next to a procedure for multi-AP based explicit sounding, FIG. 11 depicts an illustration 1100 of an exemplary multi-AP based explicit sounding procedure in accordance with the present disclosure. When there are multiple APs, one of the APs serves as a Co-ordinator AP 1110 and other AP(s) are Co-ordinated AP(s) 1120. A Multi-AP based explicit sounding procedure in accordance with the present disclosure is initiated by an Initiator frame 1150 sent by the coordinator AP 1110 to the coordinated AP(s) 1120. In the Initiator frame 1150, the allocated RU, allocated SS and Extra UHR-LTF information for each AP 1110, 1120 shall be indicated.

Next, the Coordinator AP 1110 and the coordinated AP(s) 1120 generate and send UHR NDP Announcement frames 1155a, 1155b, UHR sounding NDPs 1160a, 1160b and BFRP Trigger frames 1165a, 1165b to associated STAs 1130, 1140, respectively, soliciting beamforming feedback 1170a, 1170b.

In the UHR NDP Announcement frame 1155a, 1155b or the UHR Sounding NDP 1160a, 1160b, the Extra UHR-LTF information for each STA 1130, 1140 shall be indicated. The receiver STAs 1130, 1140 shall generate and send the beamforming feedback/CQI 1170a, 1170b based on enhanced channel estimation calculated from the UHR sounding NDP 1160a, 1160b if there is Extra UHR-LTF assigned. In this case, the size of the UHR Compressed Beamforming feedback/CQI 1170a, 1170b is advantageously smaller because only a channel state information of specific spatial streams is fed back. It will be appreciated that a respective SIFS may exist between 1150, 1155a, 1160a, 1165a, and 1170a. Similarly, a respective SIFS may exist between 1155b, 1160b, 1165b, and 1170b. Also, the beamforming feedback/CQI1 and beamforming feedback/CQI2 (i.e., 1170a and 1170b) may be transmitted simultaneously. Thus, the SIFS between 1165a and 1170a/1170b may be equal to the SIFS between 1165b and 1170a/1170b.

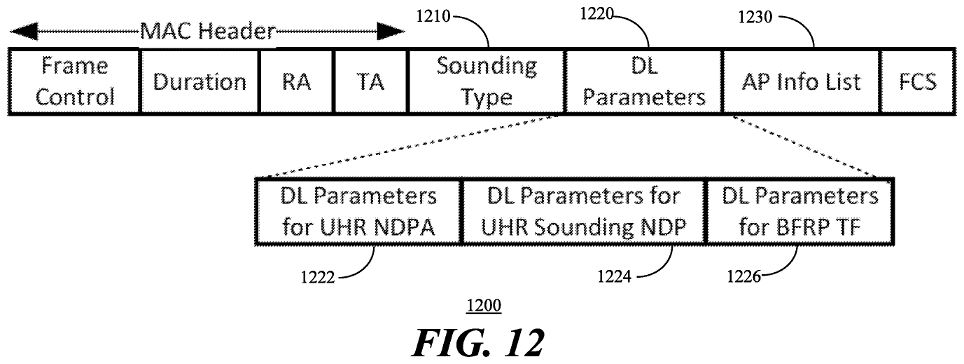

Referring to FIG. 12, an illustration 1200 depicts an exemplary initiator frame format in accordance with the present disclosure. Within a Sounding Type field 1210, the type of sounding that will be initiated is specified. In the downlink (DL) Parameters field 1220, the DL transmission parameters of a PPDU carrying the subsequent UHR NDPA frame 1222, the UHR Sounding NDP 1224 and the BFRP Trigger frame 1226 is indicated. In the AP Info List field 1230, one or more Per AP Info subfields are comprised in which the Extra-LTF Allocation information shall be indicated.

There are two options for the UHR NDPA frame 1155a, 1155b and the UHR Sounding NDP 1160a, 1160b transmission. Under the first option, the UHR NDPA frame 1155a, 1155b and UHR Sounding NDP 1160a, 1160b transmission is transmitted in a C-OFDMA manner. The UHR NDPA frame 1155a, 1155b sent by different Aps may carry different information and the UHR NDPA frame 1155a, 1155b is transmitted to associated STAs by each AP. The UHR Sounding NDPs 1160a, 1160b with different preamble signalings may be transmitted by different Aps to their associated non-AP STAs. The applicable multi-AP transmission schemes in accordance with the present disclosure include at least C-OFDMA and C-SR.

In accordance with the second option, the UHR NDPA frame 1155a, 1155b and the UHR Sounding NDP 1160a, 1160b transmission is transmitted in a joint transmission manner. In this manner, an identical UHR NDPA frame 1155 and the UHR Sounding NDP 1160 shall be transmitted by different Aps to all STAs. The applicable multi-AP transmission schemes in accordance with the present disclosure include at least Joint transmission and C-BF.

The usage of Extra UHR-LTF symbols in the subsequent UHR Sounding NDP 1160a, 1160b may be indicated in the UHR NDPA frame 1155a, 1155b or in the preamble of the UHR sounding NDP 1160a, 1160b similar to the single AP situation discussed hereinabove. Likewise, there are two options to generate UHR-LTF symbols when there is Extra UHR-LTF symbol(s) assigned to specific SS(s) and for the receiver to decode UHR-LTF symbols as discussed hereinabove. Further, in the UHR-LTF field of a UHR Sounding NDP 1160a, 1160b, the Initial UHR-LTF symbols and Extra UHR-LTF symbols can be either generated together with a same P matrix or generated separately with different P matrices. In addition, for the receiver non-AP STA, the decoding of the UHR-LTF field of the UHR Sounding NDP should correspondingly use same or different permuted P matrices to obtain the enhancement and advantages in accordance with the present disclosure for specific allocated SSs during the channel estimation calculation.

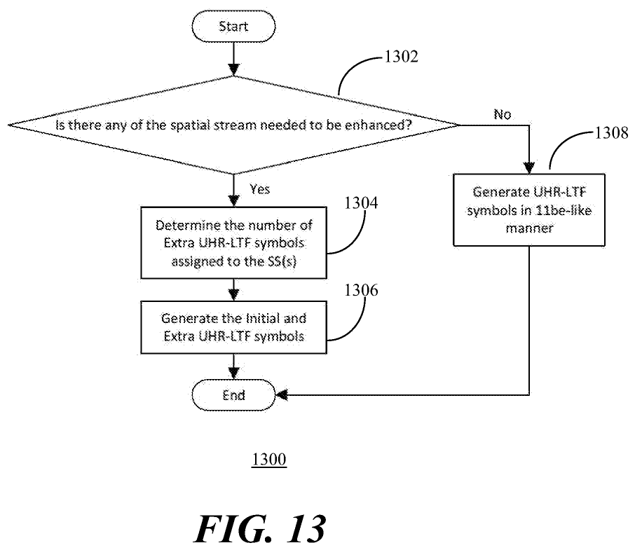

FIG. 13 is a flowchart 1300 of the UHR-LTF generation procedure in a UHR sounding NDP for explicit sounding in accordance with the present disclosure. If there are any spatial streams that need to be enhanced at step 1302, then the number of Extra UHR-LTF symbols assigned to the spatial stream(s) are determined at step 1304 and the Initial and Extra UHR-LTF symbols are generated at step 1306. When there are not any spatial streams that need to be enhanced at step 1302, the UHR-LTF symbols are generated in an IEEE 802.11be-like manner at step 1308.

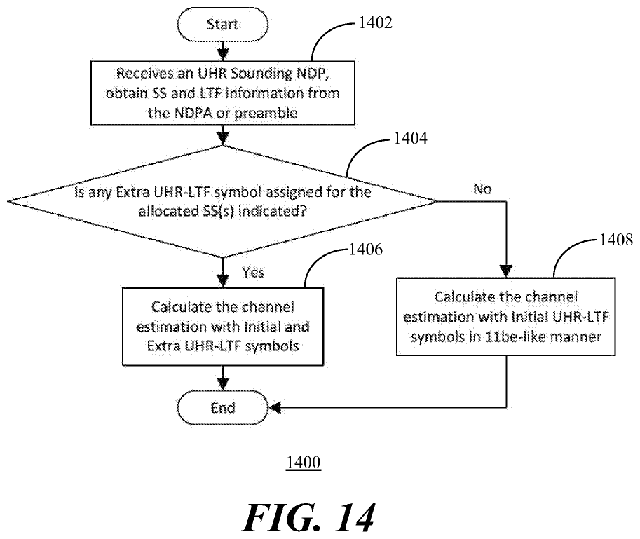

FIG. 14 is a flowchart 1400 of a decoding procedure for the UHR-LTF field in the UHR Sounding NDP by a non-AP STA in accordance with the present disclosure. When a non-AP STA received a UHR Sounding NDP, the STA obtains spatial stream and LTF information from the NDPA frame or the preamble of the UHR Sounding NDP at step 1402. In step 1404, if there are any Extra UHR-LTF symbols assigned for the allocated spatial stream(s) indicated, then the channel estimation is calculated with initial and extra UHR-LTF symbols at step 1406. When there are not any Extra UHR-LTF symbols assigned for the allocated spatial stream(s) indicated at step 1404, the channel estimation is calculated with the initial UHR-LTF symbols in an IEEE 802.11be-like manner at step 1408.

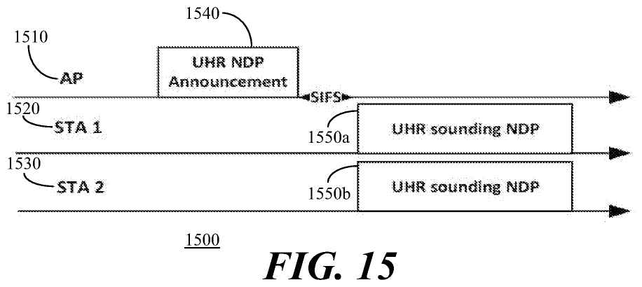

Next, the situation for single-AP base implicit sounding is discussed. FIG. 15 depicts an illustration 1500 of a single-AP based implicit sounding procedure initiated by a UHR NDP Announcement frame 1540 sent by an AP 1510. In the UHR NDP Announcement frame 1540, the allocated RU, allocated SS and Extra-LTF information for each STA 1520, 1530 is indicated. The UHR NDP Announcement frame 1540 respectively soliciting UHR Sounding NDP 1550a and 1550b from the STAs 1520 (e.g., STA 1) and 1530 (e.g., STA 2) may be a variant of a Trigger frame. After a SIFS, the receiver STAs generate and send the respective UHR sounding NDPs 1550a, 1550b following the indicated information. A Single-AP based explicit sounding procedure or Multi-AP based explicit sounding procedure can be reused as a calibration procedure.

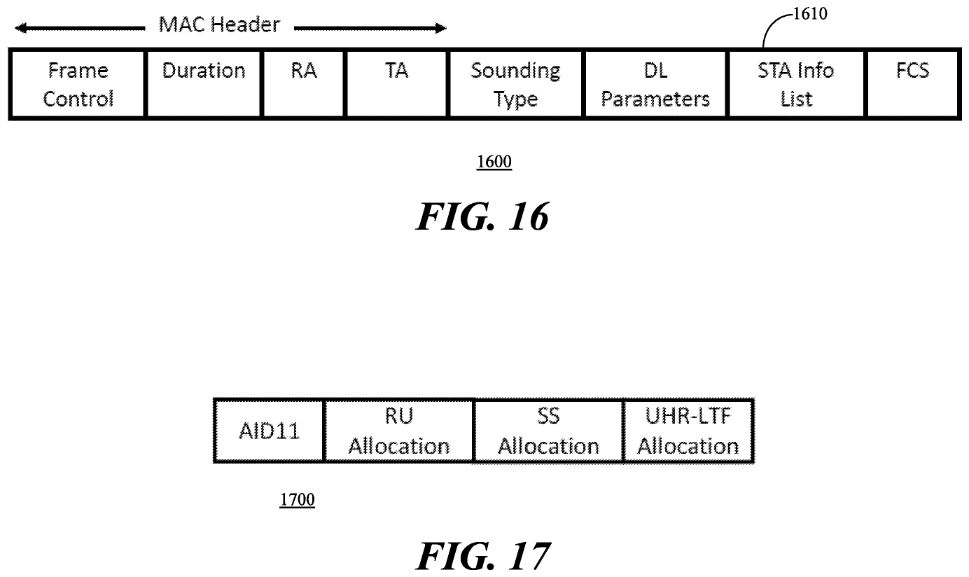

FIG. 16 is an illustration 1600 of a UHR NDP Announcement frame format in accordance with the present disclosure. In the STA Info List field 1610, one or more PER STA Info subfields may be included. FIG. 17 is an illustration 1700 of a Per STA Info subfield in accordance with the present disclosure. There are two options to generate UHR-LTF symbols when there is Extra UHR-LTF symbol(s) assigned to specific SS(s) and for the receiver to decode UHR-LTF symbols similar to the options discussed hereinabove.

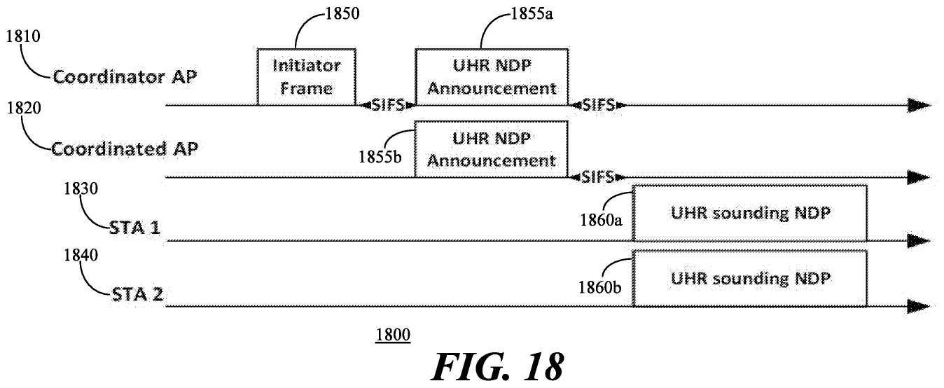

FIG. 18 depicts an illustration 1800 of a multi-AP based implicit sounding procedure in accordance with the present disclosure. The multi-AP based implicit sounding procedure is initiated by an Initiator frame 1850 sent by the coordinator AP 1810 to coordinated AP(s) 1820. In the Initiator frame 1850, the sounding type, allocated RU, allocated SS and Extra UHR-LTF information for each group of STAs 1830, 1840 associated with each AP 1810, 1820 are indicated. The coordinator AP 1810 and the coordinated AP(s) 1820 generate and send UHR NDP Announcement frames 1855a, 1855b to associated STAs 1830, 1840, respectively, to solicit UHR sounding NDPs 1860a, 1860b for implicit sounding. In the UHR NDP Announcement frame 1855a, 1855b, the allocated RU, allocated SS and Extra UHR-LTF information for each STA 1830, 1840 are indicated. A Single-AP based explicit sounding procedure or Multi-AP based explicit sounding procedure can be reused as a calibration procedure. It will be appreciated that, a respective SIFS may exist between 1850, 1855a, 1860a. Similarly, a respective SIFS may exist between 1855b and 1860a and between 1855b and 11860b. Also, the UHR sounding NDP 1860a, 1860b may be transmitted simultaneously. Thus, the SIFS between 1855a and 18600a/1860b may be equal to the SIFS between 1855b and 1860a/1860b.

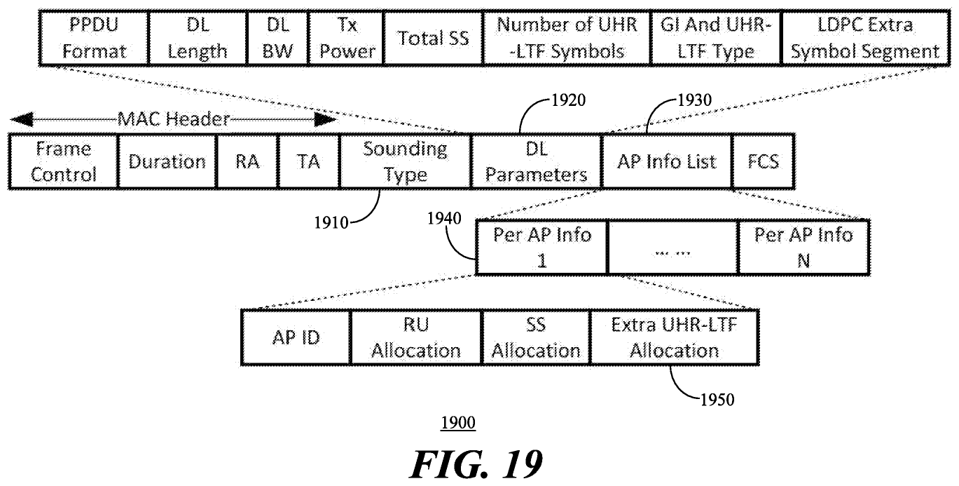

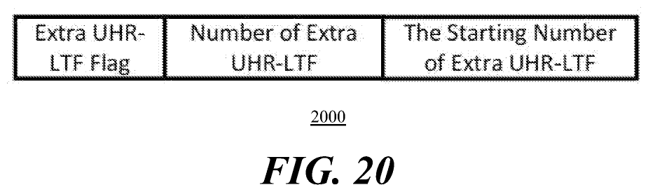

FIG. 19 is an illustration 1900 of an exemplary initiator frame format in accordance with the present disclosure. In a Sounding Type field 1910, the type of sounding that will be initiated is specified. In a DL Parameters field 1920, the DL transmission parameters of PPDU carrying the subsequent UHR NDPA frame shall be indicated. In an AP Info List field 1930, one or more Per AP Info subfields 1940 are included. Within a Per AP Info subfield is a UHR-LTF Allocation 1950 and FIG. 20 is an illustration 2000 of an exemplary UHR-LTF Allocation 1950 in accordance with the present disclosure.

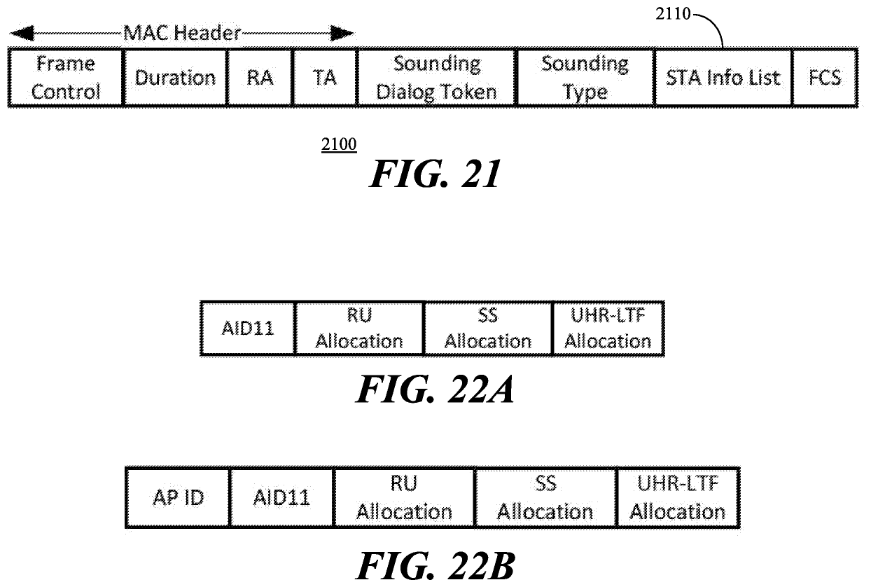

FIG. 21 is an illustration 2100 of a UHR NDP Announcement frame format in accordance with the present disclosure. There are two options for UHR NDPA frame transmission for implicit sounding. In accordance with the first option, the UHR NDPA frame is transmitted in a C-OFDMA manner. The UHR NDPA frames sent by different APs may carry different information and the UHR NDPA frames are transmitted to associated STAs by each AP. The applicable Multi-AP transmission schemes include at least C-OFDMA and C-SR.

In accordance with the first option, the UHR NDPA frame is transmitted in a joint transmission manner and identical UHR NDPA frames are transmitted by different APs to all STAs. The applicable Multi-AP transmission schemes include at least Joint transmission and C-BF.

In the STA Info List field 2110, one or more Per STA Info subfields are included. FIG. 22A depicts an exemplary Per STA Info subfield in accordance with a first option that the UHR NDPA frame is transmitted in a C-OFDMA manner. FIG. 22B depicts an exemplary Per STA Info subfield in accordance with a second option that the UHR NDPA frame is transmitted in a joint transmission manner. Also, there are two options to generate UHR-LTF symbols when there is Extra UHR-LTF symbol(s) assigned to specific SS(s) and for the receiver to decode UHR-LTF symbols as discussed hereinabove.

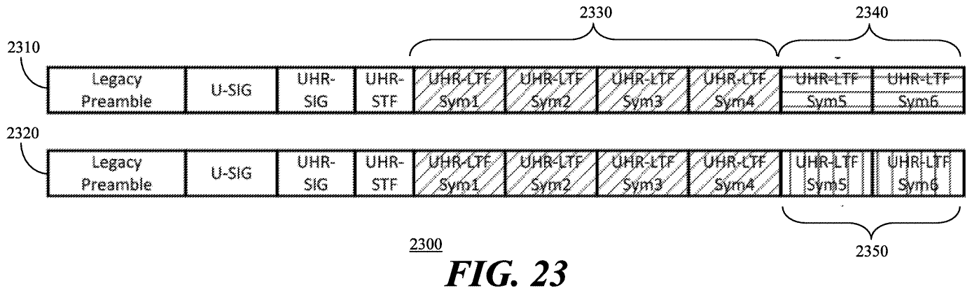

FIG. 23 is an illustration 2300 of UHR NDP sounding frames 2310, 2320 sent by STA1 and STA2, respectively, in accordance with the present disclosure. It is indicated that spatial streams 1 and 2 and no Extra UHR-LTF symbols are assigned to STA1 and spatial streams 3 and 4 and two extra UHR-LTF symbols (Sym) are assigned to STA2. In the UHR sounding NDP 2310, Sym1-Sym4 2330 carry channel information for spatial streams 14 (e.g., Sym1-Sym4 2330 are to be used for channel estimation for spatial streams 1-4 by the recipient STA of the UHR sounding NDP 2310). In Sym5 and Sym6 2340, no channel information for spatial streams 1-2 is carried. However, in the UHR sounding NDP 2320, in Sym5 and Sym6 2350, channel information for spatial streams 3-4 is carried. In this case, for spatial streams 3-4, the number of UHR-LTF symbols used to carry each spatial stream is two, thereby advantageously achieving 1.3× gain for spatial streams 3-4 compared with when the same total number of UHR-LTF symbols are used to carry four spatial streams (1.5).

In the UHR-LTF field of a UHR Sounding NDP, the Initial UHR-LTF symbols and Extra UHR-LTF symbols can be either generated together with a same P matrix or generated separately with different P matrices. For the receiver AP, the decoding of the UHR-LTF field of the UHR Sounding NDP should correspondingly use same or different permuted P matrices to obtain the enhancement for specific spatial streams during the channel estimation calculation.

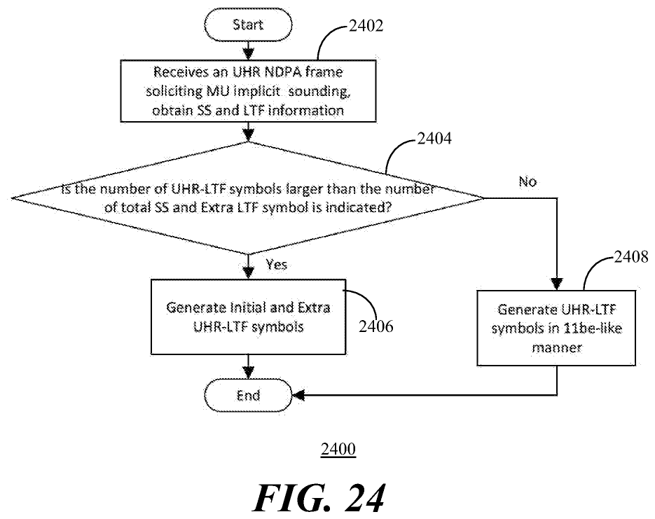

FIG. 24 is a flowchart 2400 of a UHR-LTF filed generation procedure in a UHR Sounding NDP by a non-AP STA in accordance with an embodiment of the present disclosure. When a non-AP STA receives a UHR NDPA frame soliciting MU implicit sounding, the STA obtains spatial stream and LTF information in step 2402. In step 2404, if the number of the UHR-LTF symbols is larger than the number of total spatial streams and Extra LTF symbols indicated, then initial and extra UHR-LTF symbols are generated in step 2406. In step 2404, when the number of the UHR-LTF symbols is not larger than the number of total spatial streams and Extra LTF symbols indicated, the UHR-LTF symbols are generated in an IEEE 802.11be-like manner at step 2408

For explicit and implicit sounding procedure, the Nss, Enhanced Nss and corresponding initial N_UHR-LTF, total N_UHR-LTF and the mathematical number of UHR-LTFs carrying a single enhanced spatial stream when there is Extra UHR-LTF is calculated by Equation (11).

$${N}_{LTF\_eachSS} = \frac{{N}_{I\_UHRLTF}}{{N}_{SS}} + \frac{{N}_{E\_UHRLTF}}{{N}_{Enhanced\_SS}} \qquad ( 11 )$$

where N_{I_UHRLTF} is the total number of Initial UHR-LTF symbols, N_{E_UHRLTF} is the total number of Extra UHR-LTF symbols assigned the enhanced SSs, and N_{Enhanced_SS} is the total number of enhanced spatial streams (SS).

For explicit and implicit sounding procedure, the Nss, Enhanced Nss and corresponding initial N_UHR-LTF, total N_UHR-LTF and the mathematical number of UHR-LTFs carrying a single enhanced spatial stream when there is Extra UHR-LTF is shown in Table 2.

TABLE 2

| | Enhanced | Initial | | N_UHR-LTFs/ |
|---|---|---|---|---|
| Nss | Nss | N_UHR-LTF | N_UHR-LTF | Enhanced SS |
| 1 | 1 | 1 | 2 | 2 |
| 2 | 1 | 2 | 4 | [symbol] |
| | 2 | 2 | 4 | 2 |
| 3 | 1 | 4 | 8 | 5. [symbol] |
| | 2 | 4 | 8 | 3. [symbol] |
| | 3 | 4 | 8 | 2.7 |
| 4 | 1 | 4 | 8 | 5 |
| | 2 | 4 | 8 | [symbol] |
| | 3 | 4 | 8 | 2. [symbol] |
| | 4 | 4 | 8 | 2 |
| 5 | 1 | [symbol] | 8 | 3.2 |
| | 2 | [symbol] | 8 | 2.2 |
| | 3 | [symbol] | 8 | 1.9 |
| | 4 | [symbol] | 8 | 1.7 |
| | 5 | 6 | 8 | 1.6 |
| 6 | 1 | 6 | 8 | [symbol] |
| | 2 | 6 | 8 | 2 |
| | 3 | 6 | 8 | 1.7 |
| | 4 | 6 | 8 | 1. [symbol] |
| | 5 | 6 | 8 | 1.4 |
| | 6 | 6 | 8 | 1.3 |
| 7 | 1 | 8 | 8 | 3.1 |
| | 2 | 8 | 8 | 2.2 |
| | 3 | 8 | 8 | 1.8 |
| | 4 | 8 | 8 | 1. [symbol] |
| | 5 | 8 | 8 | 1.5 |
| | 6 | 8 | 8 | 1.4 |
| | 7 | 8 | 8 | 1.1 |
| 8 | 1 | 8 | 8 | [symbol] |
| | 2 | 8 | 8 | 2 |
| | 3 | 8 | 8 | 1.7 |
| | 4 | 8 | 8 | 1.5 |
| | 5 | 8 | 8 | 1.4 |
| | 6 | 8 | 8 | 1. [symbol] |
| | 7 | 8 | 8 | 1.1 |
| | 8 | 8 | 8 | 1 |

[symbol]

indicates data missing or illegible when filed

Exemplary embodiments provide multiple communication apparatuses and communication methods for extra-LTF in sounding in ultra-high reliability (UHR) WLAN environments. In a sounding procedure in accordance with the present disclosure, the channel estimation accuracy of specific spatial streams is advantageously enhanced. In addition, in a UHR Sounding NDP, UHR-LTF symbols can be divided into two groups: one group of LTF symbols carry channel information evenly for all spatial streams and another group of LTF symbols carry channel information for specific spatial streams.

Further, two groups of UHR-LTF symbols can be generated together with a same P matrix or generated separately with different P matrices. Channel estimation is calculated from two groups of received UHR-LTF symbols separately with different P matrices. In the frame initiating a sounding procedure, the information regarding enhancement for specific spatial streams is indicated.

Thus, it can be seen that in one aspect of Multi-AP scenarios, the requirement for channel estimation accuracy in sounding can be different between each group of STAs. UHR-LTFs of a sounding NDP can thus be divided into two groups in accordance with the present disclosure: one group of UHR-LTFs for all spatial streams and another group of UHR-LTFs for specific spatial streams.

In an explicit sounding procedure, the extra LTF information is indicated prior to or during the sounding NDP transmission. In an implicit sounding procedure, the SS and LTF allocation is indicated prior to or in the NDPA transmission. Two groups of UHR-LTF symbols can be either generated together with a same P matrix or generated separately with different P matrices.

Accordingly, apparatuses and methods in accordance with the present disclosure provide enhanced sounding procedures where extra LTFs can be assigned to specific spatial streams, thereby enhancing the channel estimation accuracy of specific spatial streams with less LTFs as compared with current 802.11be solutions.

The present disclosure can be realized by software, hardware, or software in cooperation with hardware. Each functional block used in the description of each embodiment described above can be partly or entirely realized by an integrated circuit (IC) such as a large-scale integration (LSI), and each process described in each embodiment may be controlled partly or entirely by a same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, a very-large-scale integration (VLSI), or an ultra-LSI depending on the integration scales. However, the technique of implementing an integrated circuit is not limited to the LSI and may be realized by using a dedicated circuit, a general purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing. The functional blocks could be integrated with various integrated circuit technologies which are not limited to those mainly used at present. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more amplifiers, RF modulators/demodulators and the like, and one or more antennas. The processing/control circuitry may include power management circuitry which may comprise dedicated circuitry, a processor and instructions for power management control as either firmware or instructions stored in a memory coupled to the processor.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IOT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such an access point, and any other apparatus, device or system that communicates with or controls apparatuses such as those in the non-limiting examples provided herein.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the STA communication apparatus and/or the AP communication apparatus described in the exemplary embodiments without departing from the scope of the present disclosure as set forth in the appended claims.

1. A communication apparatus operating as an access point in a wireless local area network (WLAN), the communication apparatus comprising:
a transmitter, which in operation, is configured to transmit signals to at least one peer communication apparatus in the WLAN; and
circuitry, which in operation, generates a first signal to initiate a sounding procedure, wherein the first signal comprises first information to indicate to the at least one peer communication apparatus spatial stream allocation information, and wherein the transmitter transmits the first signal to the at least one peer communication apparatus.

2. The communication apparatus in accordance with claim 1 wherein the at least one peer communication apparatus comprises at least one wireless station in the WLAN.

3. The communication apparatus in accordance with claim 1 or claim 2 wherein the communication apparatus operating as the access point comprises a coordinating access point.

4. The communication apparatus in accordance with any of the previous claims wherein the first signal comprises second information to indicate allocation and grouping information for non-legacy long training field (LTF) symbols used in the sounding procedure, the non-legacy LTF symbols being grouped into one or more groups.

5. The communication apparatus in accordance with any of the previous claims wherein the circuitry generates a second signal configured for sounding channel states at the at least one peer communication apparatus, and wherein the transmitter transmits the second signal to the at least one peer communication apparatus.

6. The communication apparatus in accordance with claim 5 wherein the circuitry further generates a third signal configured to solicit feedback regarding channel states calculated with the one or more groups of non-legacy LTF symbols of the first signal from the at least one peer communication apparatus, and wherein the transmitter transmits the third signal to the at least one peer communication apparatus.

7. The communication apparatus in accordance with claim 5 or claim 6 wherein spatial streams of the second signal are grouped into one or more groups of spatial streams, wherein a first of the one or more groups of spatial streams is mapped to a first group of non-legacy LTF symbols in response to a first P matrix and wherein a second of the one or more groups of spatial streams is mapped to a second group of non-legacy LTF symbols in response to a second P matrix.

8. The communication apparatus in accordance with claim 7 wherein the first of the one or more groups of spatial streams includes the second group of spatial streams.

9. The communication apparatus in accordance with claims 5 to 8 wherein the second signal comprises information to indicate the one or more groups of non-legacy LTF symbols and the one or more spatial streams.

10. A communication apparatus comprising:
a receiver, which in operation, is configured to receive signals from at least one access point in a wireless local area network (WLAN); and
circuitry, which in operation, receives a first signal to initiate a sounding procedure, wherein the first signal comprises first information to indicate to the at least one wireless station spatial stream allocation information, and wherein the circuitry decodes the first signal, obtains the first information, and generates a second signal solicited by the first signal; and
a transmitter coupled to the circuitry and configured to transmit the second signal to the at least one access point.

11. The communication apparatus in accordance with claim 10 wherein the second signal solicited by the first signal comprises a feedback signal solicited by the first signal, and wherein the circuitry is configured to calculate channel states and generate the feedback signal in response to the calculated channel states.

12. The communication apparatus in accordance with claim 10 or claim 11 wherein the circuitry, in operation, receives a third signal comprising spatial streams grouped into one or more groups of spatial streams, and wherein the circuitry is further configured to decode a first group of non-legacy LTF symbols from a first of the one or more groups of spatial streams by applying a first permuted P matrix and to decode a second group of non-legacy LTF symbols from a second of the one or more groups of spatial streams by applying a second permuted P matrix.

13. A method in a wireless local area network (WLAN), the method comprising:
generating a first signal to initiate a sounding procedure in the WLAN, wherein the first signal comprises first information to indicate to at least one peer communication apparatus spatial stream allocation information; and transmitting the first signal to at least one peer communication apparatus in the WLAN.

14. The method in accordance with claim 13 wherein the first signal comprises second information to indicate allocation and grouping information for non-legacy long training field (LTF) symbols used in the sounding procedure, the non-legacy LTF symbols being grouped into one or more groups.

15. The method in accordance with claim 13 or claim 14 further comprising:
generating a second signal configured for sounding channel states at the at least one peer communication apparatus; and
transmitting the second signal to the at least one peer communication apparatus.

16. The method in accordance with claim 15 further comprising:
generating a third signal configured to solicit feedback regarding channel states calculated with the one or more groups of non-legacy LTF symbols of the first signal from the at least one peer communication apparatus; and
transmitting the third signal to the at least one peer communication apparatus.

17. The method in accordance with claim 15 or claim 16 wherein spatial streams of the second signal are grouped into one or more groups of spatial streams, and wherein a first of the one or more groups of spatial streams is mapped to a first group of non-legacy LTF symbols in response to a first P matrix, and wherein a second of the one or more groups of spatial streams is mapped to a second group of non-legacy LTF symbols in response to a second P matrix.

18. The method in accordance with claim 17 wherein the first of the one or more groups of spatial streams includes the second group of spatial streams.

19. The method in accordance with claims 15 to 18 wherein the second signal comprises information to indicate the one or more groups of non-legacy LTF symbols and the one or more spatial streams.

20. A communication apparatus comprising:
receiving a first signal from at least one access point in a wireless local area network (WLAN) to initiate a sounding procedure, wherein the first signal comprises first information to indicate to the at least one wireless station spatial stream allocation information;
decoding the first signal to obtain the first information;
generating a second signal solicited by the first signal; and
transmitting the second signal to the at least one access point.

21. The communication apparatus in accordance with claim 20 wherein the second signal solicited by the first signal comprises a feedback signal solicited by the first signal, and wherein generating the second signal comprises calculating channel states and generating the feedback signal in response to the calculated channel states.

22. The communication apparatus in accordance with claim 20 or claim 21 further comprising:
receiving a third signal comprising spatial streams grouped into one or more groups of spatial streams;
decoding a first group of non-legacy LTF symbols from a first of the one or more groups of spatial streams by applying a first permuted P matrix; and
decoding a second group of non-legacy LTF symbols from a second of the one or more groups of spatial streams by applying a second permuted P matrix.

1. A communication apparatus operating as an access point in a wireless local area network (WLAN), the communication apparatus comprising:
a transmitter, which in operation, is configured to transmit signals to at least one peer communication apparatus in the WLAN; and
circuitry, which in operation, generates a first signal to initiate a sounding procedure, wherein the first signal comprises first information to indicate to the at least one peer communication apparatus spatial stream allocation information, and wherein the transmitter transmits the first signal to the at least one peer communication apparatus.

2. The communication apparatus in accordance with claim 1 wherein the at least one peer communication apparatus comprises at least one wireless station in the WLAN.

3. The communication apparatus in accordance with claim 1 wherein the first signal comprises second information to indicate allocation and grouping information for non-legacy long training field (LTF) symbols used in the sounding procedure, the non-legacy LTF symbols being grouped into one or more groups.

4. The communication apparatus in accordance with claim 1 wherein the circuitry generates a second signal configured for sounding channel states at the at least one peer communication apparatus, and wherein the transmitter transmits the second signal to the at least one peer communication apparatus.

5. The communication apparatus in accordance with claim 4 wherein the circuitry further generates a third signal configured to solicit feedback regarding channel states calculated with the one or more groups of non-legacy LTF symbols of the first signal from the at least one peer communication apparatus, and wherein the transmitter transmits the third signal to the at least one peer communication apparatus.

6. The communication apparatus in accordance with claim 4 wherein spatial streams of the second signal are grouped into one or more groups of spatial streams, wherein a first of the one or more groups of spatial streams is mapped to a first group of non-legacy LTF symbols in response to a first P matrix and wherein a second of the one or more groups of spatial streams is mapped to a second group of non-legacy LTF symbols in response to a second P matrix.

7. The communication apparatus in accordance with claim 6 wherein the first of the one or more groups of spatial streams includes the second group of spatial streams.

8. The communication apparatus in accordance with claim 4 wherein the second signal comprises information to indicate the one or more groups of non-legacy LTF symbols and the one or more spatial streams.

9. A communication apparatus comprising:
a receiver, which in operation, is configured to receive signals from at least one access point in a wireless local area network (WLAN); and
circuitry, which in operation, receives a first signal to initiate a sounding procedure, wherein the first signal comprises first information to indicate to the at least one wireless station spatial stream allocation information, and wherein the circuitry decodes the first signal, obtains the first information, and generates a second signal solicited by the first signal; and
a transmitter coupled to the circuitry and configured to transmit the second signal to the at least one access point.

10. The communication apparatus in accordance with claim 9 wherein the second signal solicited by the first signal comprises a feedback signal solicited by the first signal, and wherein the circuitry is configured to calculate channel states and generate the feedback signal in response to the calculated channel states.

11. The communication apparatus in accordance with claim 9 wherein the circuitry, in operation, receives a third signal comprising spatial streams grouped into one or more groups of spatial streams, and wherein the circuitry is further configured to decode a first group of non-legacy LTF symbols from a first of the one or more groups of spatial streams by applying a first permuted P matrix and to decode a second group of non-legacy LTF symbols from a second of the one or more groups of spatial streams by applying a second permuted P matrix.

12. A method in a wireless local area network (WLAN), the method comprising:
generating a first signal to initiate a sounding procedure in the WLAN, wherein the first signal comprises first information to indicate to at least one peer communication apparatus spatial stream allocation information; and
transmitting the first signal to at least one peer communication apparatus in the WLAN.

13. The method in accordance with claim 12 wherein the first signal comprises second information to indicate allocation and grouping information for non-legacy long training field (LTF) symbols used in the sounding procedure, the non-legacy LTF symbols being grouped into one or more groups.

14. The method in accordance with claim 12 further comprising:
generating a second signal configured for sounding channel states at the at least one peer communication apparatus; and
transmitting the second signal to the at least one peer communication apparatus.

15. The method in accordance with claim 14 further comprising:
generating a third signal configured to solicit feedback regarding channel states calculated with the one or more groups of non-legacy LTF symbols of the first signal from the at least one peer communication apparatus; and
transmitting the third signal to the at least one peer communication apparatus.

16. The method in accordance with claim 14 wherein spatial streams of the second signal are grouped into one or more groups of spatial streams, and wherein a first of the one or more groups of spatial streams is mapped to a first group of non-legacy LTF symbols in response to a first P matrix, and wherein a second of the one or more groups of spatial streams is mapped to a second group of non-legacy LTF symbols in response to a second P matrix.

17. The method in accordance with claim 14 wherein the second signal comprises information to indicate the one or more groups of non-legacy LTF symbols and the one or more spatial streams.

18. A communication apparatus comprising:
receiving a first signal from at least one access point in a wireless local area network (WLAN) to initiate a sounding procedure, wherein the first signal comprises first information to indicate to the at least one wireless station spatial stream allocation information;
decoding the first signal to obtain the first information;
generating a second signal solicited by the first signal; and
transmitting the second signal to the at least one access point.

19. The communication apparatus in accordance with claim 18 wherein the second signal solicited by the first signal comprises a feedback signal solicited by the first signal, and wherein generating the second signal comprises calculating channel states and generating the feedback signal in response to the calculated channel states.

20. The communication apparatus in accordance with claim 18 further comprising:
receiving a third signal comprising spatial streams grouped into one or more groups of spatial streams;
decoding a first group of non-legacy LTF symbols from a first of the one or more groups of spatial streams by applying a first permuted P matrix; and
decoding a second group of non-legacy LTF symbols from a second of the one or more groups of spatial streams by applying a second permuted P matrix.
